(19) United States
(12) Patent Application Publication
(10) Pub. No.: US 2018/0336592 A1
(43) Pub. Date: Nov. 22, 2018

(54) SYSTEM, APPARATUS AND METHOD FOR PROVIDING LOCATION BASED SERVICES

(71) Applicant: Vishnu P. Kurra, Ashburn, VA (US)

(72) Inventor: Vishnu P. Kurra, Ashburn, VA (US)

(21) Appl. No.: 15/596,534

(22) Filed: May 16, 2017

(51) Int. Cl. G06Q 30/02; G06F 17/30; G06Q 50/00

(52) U.S. Cl. CPC G06Q 30/0261; G06Q 50/01; G06F 17/30867

(57) ABSTRACT

Embodiments of the present invention disclose a computer system comprising an execution environment for running a social networking platform stored locally on a memory of the computer system. The social networking platform comprises an interface for enabling communication between registered/non-registered users, wherein the users may be individuals as well as business entities. The social networking platform further comprises a database storing user preferences for sending and receiving data over the social networking platform. Based on the user preferences, a user can ensure that only relevant information is received. Further, the user is allowed to sell products and services over the social networking platform to other users based on their current geographical locations. Furthermore, the user is provided with a platform to advertise business listings and other promotional schemes. The user can also rate/recommend/comment/broadcast on products and services and share them with other users.

### FIELD OF THE INVENTION

Embodiments of the present invention in general, concern a system, apparatus, and method to provide services to a user over a network. More particularly, embodiments of the present invention provide the services to the user based on user's geographical location.

### BACKGROUND OF THE INVENTION

Recently, with the elevation in the technology, pricing of gadgets such as cell phones, tablets, laptops, etc. has significantly declined. The decline in the pricing made the gadgets more affordable to majority of user across the globe. Now, as the majority of global population owns such gadgets, advertising industry also inclined towards targeting such gadgets for pushing advertisements, instead of using traditional approaches like printing pamphlets, posters, or advertising over radio and television.

Initially, majority of the worldwide gadget owners were far from using Internet. Therefore, the advertising industries used to broadcast their advertisements via SMS services or via tele-callers. However, due to limited information available about the owners of the gadgets, the advertisements used to be generic or off-targeted. For obvious reasons, success rates of such off-targeted advertisements were significantly low.

Thereafter, when the Internet connections became affordable and widely available, the advertising industries moved to targeted advertisements. Such targeted advertisements were customized based on basic information about Internet users, such as their, browsing history, age, gender, etc. Undoubtedly, these targeted advertisements were very successful. However, the success rates of such targeted advertisements still left the advertising industries in wanting more.

Evidently, the solution of further increasing the success rates was lying in further personalizing the advertisements. However, the Internet could offer only limited information about users due to ethical, legal, and technical restrictions. Therefore, the advertising industries began to explore new horizons for gathering more personalized information corresponding to their customers. Therefore, there is still a need for a system and method that is capable of solving the aforementioned problems and to enhance the success rates of the advertisements without overwhelming Internet users.

The applicant has devised, tested and embodied the present invention to overcome the shortcomings of the state of the art and to obtain these and other purposes and advantages.

### SUMMARY OF THE INVENTION

Embodiments in accordance with the present invention disclose a method to facilitate social networking between multiple registered/non-registered users. The method comprises a step by step process. The step by step process comprises facilitating a first user to send an information to a second user, wherein the information comprises at least one of an advertisement, business listing, social network post, message, recommendation, audio, video, text, graphics, or a combination thereof in relevance to a geographical location. The process further comprises determining whether the second user is in vicinity of the geographical location and determining whether registered/non-registered preferences of the second user allows the second user to receive the information sent by the first user. The process further comprises displaying the information to the second user if allowed by the second user's registered/non-registered preferences.

The process further comprises receiving recommendation from the second user on the displayed information and a list of users who have subscribed to follow activities of the second user (or list of users who are in friend list of the second user) and are also eligible to receive the information based on their own registered/non-registered preferences. Thereafter, the information is displayed to the determined list of users along with a notification that the second user recommended the information. The process further comprises notifying the second user a count and list of users who have recommended the information, wherein the count and list of users are of only those users who are subscribed by the second user. The process further comprises notifying the determined list of users a count and list of users who have subscribed to follow their activities (or are in friend list) and have also recommended the information.

The process further comprises determining whether the second user re-entered in vicinity of the geographical location and determining whether the registered/non-registered preferences of the second user allows the second user to receive the information second time. The process further comprises displaying the information to the second user if allowed by the second user's registered/non-registered preferences. Also displayed to the second user is a count and list of users who have subscribed to follow second user's activities and have also recommended the information.

Further, the social networking module serves as a platform for consumers and vendors to consume/host a service or to buy/sell products. The social networking module also serves as a communication platform for various users to interact with each other. The social networking module may further allow the users to advertise over the platform. The social networking module may further allow the users to post updates, messages, recommendations for services/products, etc. The social networking module may further allow the users to rate services and products. The social networking module may further allow the users to post and recommend job vacancies. The social networking module may further allow the users to book or buy services such as movies, food, etc.

Embodiments in accordance with the present invention further disclose an electronic device such as a smart-phone, laptop, tablet, server, etc. The electronic device comprises a processor, a positioning module, a network interface, and a memory. The positioning module enables the electronic device to determine geographic locations of any registered/non-registered user. The memory comprises a database and an instruction set. The database comprises profiles of registered/non-registered users (comprising individuals and business entities). In an embodiment, the profiles of non-registered users may be sourced from third party databases.

The instruction set comprises instructions which when executed by the processor, causes the processor to perform a step by step process. The process comprises facilitating a first user to send an information to a second user, wherein the information comprises at least one of an advertisement, business listing, message, recommendation, social network post, audio, video, text, graphics, or a combination thereof pertaining to a commercial item. The second user may be one or more individuals or business entities.

The commercial item may comprise any service or a product. For example, the commercial item may comprise a job listing, electronic products, child day care service, pet day care service, night club service, casino, bars, etc. The commercial item may further comprise coupons for food, drinks, restaurants, bars, electronics, beauty saloons, spa, fitness clubs, traveling, apparels, automotive services, activities, night life, shopping, health etc.

The commercial item may further comprise restaurants, fast food outlets, bakery stores, cafes, delivery outlets, etc. The commercial item may further comprise shopping malls, clothing stores, supermarkets, department stores, etc. The commercial item may further comprise services such as home service, real estate service, plumbing service, lawn care service, maintenance service, repair service, painting service, etc. The commercial item may further comprise boutiques such as dress boutiques, jewelry boutiques, footwear boutiques, accessory boutiques, etc.

The commercial item may further comprise movies, theaters, now showing movies, box office movies, coming soon movies, movie trailers, etc. the commercial entity may further comprise events, sports/games, travel (flights, hotel, can, cruise, rail, bus) ticketing, room-mates, rentals, job training, carpool, swap/trade, automotive (car services, auto dealers, auto arts, cars (buy/sell), electronics, doctors, tax services, jewelry, education (tutors etc), health and wellness, marketing (social influencers, PR, etc), animation, legal, food delivery, movers, rental, cars, books and music, rentals, apartment finder, etc.

The process further comprises determining whether the commercial item is available in vicinity of the second user and then displaying the information to the second user if the commercial item is not available in vicinity of the second user, wherein the information displayed to the second user comprises at least one of title of commercial item and count and list of users who have recommended the commercial item. The count and list of users is though restricted by count and list of users who are registered/non-registered followers of the second user.

Otherwise, the information is displayed to the second user if the commercial item is available in vicinity and the second user is further facilitated to explore details corresponding to the commercial item available in the vicinity. The details explored corresponding to the commercial item may comprise at least one of geographical location of the commercial item, distance from the second user, open and closing tunings, contact details, movie show timings, food menu, daily special menu, vacancy, reservation status, title, name of business, advertisement, navigation information, ratings, reviews, pictures, videos, website, salary, job type, price, discounts, after discount price, hourly rates, menu, URL, operation hours, offers, coupons, etc.

Embodiments in accordance with the present invention further disclose a data server. The data server comprises a processor and a memory. The memory comprises a database and an instruction set. The database comprises profiles of registered/non-registered users (comprising individuals and business entities). The instruction set comprises instructions which when executed by the processor, causes the processor to perform a step by step process. The process comprises facilitating a user to broadcast an information in one or more geographical areas, wherein the information comprises at least one of an advertisement, business listing, social network post, message, recommendation, audio, video, text, graphics, or a combination thereof.

The process further comprises determining a first set of users in vicinity of the one or more geographical areas, wherein the vicinity comprises a distance between zero to hundred miles in radius that can be updated by the user as a registered/non-registered preference analyzing registered/non-registered preferences of the first set of users to determine a second set of users qualifying for sending the broadcasted information. The one or more geographical areas may comprise one or more cities, countries, streets, malls, markets, societies, business franchises, etc. In an embodiment, a user may select a business that has multiple franchises all over the world/country/city for broadcasting the information

The process further comprises displaying the information only to the determined second set of users and determining if the second set of users ever re-enter in vicinity of the one or more geographical areas. If the second set of users re-entered then the process further analyzes registered/non-registered preferences of the second set of users to determine a third set of users qualifying for sending the broadcasted information again, wherein the third set of users are equal or less than the second set of users. The process further comprises displaying the information again only to the third set of users.

The process further comprises receiving recommendation from a fourth set of users corresponding to the displayed information, wherein the fourth set of users are equal to or less than the second set of users. The process further comprises sending the recommendation to a fifth set of users, wherein the fifth set of users are registered/non-registered followers of the fourth set of users. The process further comprises notifying the fifth set of users that the fourth set of users have recommended the information, wherein the fifth set of users are further selected based on their registered/non-registered preferences.

The registered/non-registered preferences comprise, but are not restricted to, a maximum distance from a geographical location to receive information corresponding to the geographical location, maximum number of times to receive same information, whether or not to receive same information from same users, whether or not to receive same information from same users if triggered second or consecutive times by the same users, whether or not to receive same information if triggered by a different user, whether or not to receive count and list of users triggering same information, whether or not to receive separate count and list of new users and separate count and list of old users triggering same information, whether or not to receive local version of a triggered information, etc.

These and other aspects, characteristics and advantages of the present disclosure will be better understood with reference to the following description, drawings and attached claims. The drawings, which are integrated and form part of the present description, show some forms of embodiment of the present invention, and together with the description, are intended to describe the principles of the disclosure.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1 illustrates an exemplary environment in which various embodiments of the present invention are implemented.

FIG. 2 illustrates a block diagram of an electronic device, in accordance with an embodiment of the present invention.

FIG. 3 illustrates a flow diagram of a method for allowing a user to register/select preferences on an online social networking platform over a network, in accordance with an embodiment of the present invention.

FIG. 4 illustrates a flow diagram of a method for allowing a user to advertise in multiple or popular geographical locations over an online social networking platform, in accordance with an embodiment of the present invention.

FIG. 5 illustrates a flow diagram of a method for allowing a user to publish location specific business recommendations on a social networking platform, in accordance with an embodiment of the present invention.

FIG. 6 illustrates a flow diagram of a method for allowing a user to publish recommendations on a social networking platform corresponding to a franchised business, in accordance with an embodiment of the present invention.

FIG. 7 illustrates a flow diagram of a method for tracking Geo-locations of users by a social networking platform for providing tailored services, in accordance with an embodiment of the present invention.

FIG. 8 illustrates a flow diagram of a method of providing services to registered/non-registered users of a social networking platform, in accordance with an embodiment of the present invention.

### DETAILED DESCRIPTION OF SOME FORMS OF EMBODIMENT

The description shall now refer in detail to the various form's of embodiment of the present invention, of which one or more examples are shown in the attached drawings. Each example is supplied by way of illustration of the invention and shall not be understood as a limitation thereof. For example, the characteristics shown or described insomuch as they are part of one form of embodiment can be adopted on, or in association with, other forms of embodiment to produce another form of embodiment. It is understood that the present invention shall include all such modifications and variants.

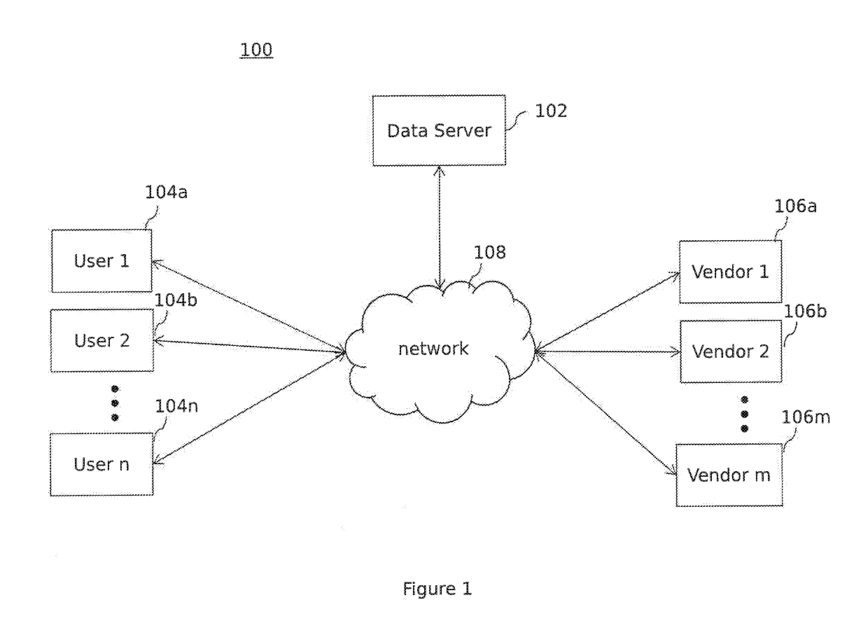

FIG. 1 illustrates an exemplary environment 100 where various embodiments of the present invention are implemented. The environment 100 includes a data server 102 connected to a plurality of devices 104-a-n and 106-a-m via a network 108, wherein the numbers n and in are arbitrary numbers representing same or different number of devices. Hereinafter, the devices 104-a-n may collectively be referred to as “user devices 104” and the vendor devices 106-a-m may collectively be referred to as “vendor devices 106”.

Further, the user devices 104 may refer to electronic devices that may be utilized by individuals (consumers or customers) to access and communicate with the data server 102. In an embodiment of the present invention, the user devices 104 are portable wireless communication devices such as but not restricted to cell phones, tablets, laptops, etc. Further, the vendor devices 106 may refer to electronic devices that may be utilized by service providers or business owners to communicate with the data server 102.

In an embodiment, the service providers or vendors may also be able to communicate with the user devices 104 via the data server 102. In another embodiment, the vendors may be able to communicate with each other via the data server 102. In another embodiment, the individuals may be able to communicate with each other via the data server 102. In another embodiment, the individuals may be able to communicate with the vendors via the data server 102.

Examples of the user devices 104 and the vendor devices 106 may include, but are not restricted to, a desktop computer, a laptop, a mobile/cell phone, a smart phone, a personal digital assistant (PDA), a tablet computer, and the like. Further, the network 108 may include, but is not restricted to, a communication network such as Internet, Intranet, PSTN, Local. Area Network (LAN), Wide Area Network (WAN), Metropolitan Area Network (MAN), and so forth.

In an exemplary embodiment of the present invention, the user devices 104 are installed with a service application (not shown), which may be implemented as a software application (or combination of software and hardware). Further, the service application installed in the user devices 104 is configured to connect the user devices 104 with multiple services offered by multiple service providers via the data server 102. The service application installed in the user devices 104 may also be configured to connect the user devices 104 with the vendor devices 106.

Similarly, in an exemplary embodiment of the present invention, the vendor devices 106 are also installed with the same service application (not shown) as installed in the user devices 104. In another embodiment of the present invention, the service application installed in the vendor devices 106 may be different from the service application installed in the user devices 104. The service application installed in the vendor devices 106 is configured to connect the vendor devices 106 with the data server 102 for hosting their services (via the data server 102) for the user devices 104.

In another embodiment of the present invention, the data server 102 may comprise a web platform (hereinafter may be referred to as ‘platform’) for hosting web services to the user devices 104 and the vendor devices 106. The web platform may enable the user devices 104 to communicate with the vendor devices 106. Further, the web platform may enable the vendor devices 106 to post and host their products or services. In an embodiment, the user devices 104 and the vendor devices 106 may access the web platform by entering domain address of the service hosted by the data server 102.

For example, a user may access the website hosted by the data server 102 or may open software application in an electronic gadget, which may connect with the data server 102. If the user accessed the data server 102 for the first time, then the user may see a Log-in or Registration page on the web-page or on the software application. The registration process may allow the user to either register as an individual or as a business entity.

If the user registers as a business entity then the user will be allowed to host business and services over the platform to reach all individuals who have registered/non-registered with the platform. The user may then provide notifications, advertisements, messages, offers, discounts, etc. to the registered/non-registered individuals via the platform. However, if the user registers as an individual then the user may be allowed to communicate with other registered/non-registered individuals and businesses entities as well. The user may also explore any business information that is registered/non-registered with the platform and may even place orders, requests, feedbacks, etc. The platform may also be used as an e-retailer platform and may be used for buying and selling products. Further, the user may also have an option to rate the business entities and may broadcast their experiences with other registered/non-registered individuals, for educating them with their experiences. The user may also have options for rating, commenting, liking, broadcasting, sharing, recommending, advertising, listing businesses, posting, messaging, uploading audio/video/graphics, etc. as part of social networking,

Further, the user may be provided an option to earn referral points by inviting other individuals or business entities on the platform. The referral points may be considered as virtual money, which the user may redeem for actual money, offers, discounts, etc. Furthermore, the user may search on the platform for known contacts (individuals or businesses) to follow their updates on the platform. The user may also be allowed to follow every registered/non-registered individual or business to receive their updates.

In an exemplary embodiment of the present invention, the service provided by the platform is a location based service which provides multiple sub-services to the users. The platform may use any state of art technology for detecting Geo-locations. The state of the art technologies may comprise, but are not restricted to, GPS, Wi-Fi, Triangulation, movement detection sensors, etc. The platform may be configured to refine offerings, products, services, content, etc. based on location of the user. The user may also be provided with an option to input its current location to experience the offerings by the platform for that particular location.

For example, the platform enables the users to find nearby food outlets, movie show timings, jobs, etc. Further, the platform allows the user to view all relevant notifications at a single page. The user may also post advertisements on the platform for promotion of their business. Also, the platform provides the users a lot of discounts and coupons, which may be a part of promotional activities sponsored by various businesses registered/non-registered with the platform.

In an exemplary embodiment, if the user selected a food service option from the platform, the user may further receive an option to select sub-food categories such as fine-dining restaurants, fast food restaurants, bakery outlets, etc. The platform will automatically refine display results based on user's selections and based on user's current Geo-location. The user may also register preferences for setting a particular distance up to which the user is willing to explore food outlets. The platform may therefore further refine the display results based on the user's preferences.

Further, if the user liked a particular food outlet and decides to notify followers (individuals or business entities following social activities of the user) that this particular outlet is good or serves a particular dish which is great, then the user can broadcast this information in its social circle. When one or more of the follower of the user enters in proximity (proximity distance may be pre-set) of that particular outlet (or its franchise), they will receive the notification that one user (name of the user may be displayed) in their circle has recommended this place. If more of their followers have also recommended the same place, then they will receive a single notification defining the count and list of followers who have recommended the place. The platform may further provide an option to them to navigate through details of each individual notification.

The users may also have an option to select if they want to receive same notifications (as a reminder) again and again whenever they enter in proximity of any promoted business/text/images/videos/advertisements/post, or whether they are interested in receiving only new notifications every time they enter in proximity of the same business. If the users selected to receive only new notifications, then whenever they enter in proximity of same promoted business/text/images/videos/advertisements/post location for second or consecutive times, the platform will only send a notification to the users if one or more new users from their circle have recommended the same business, for which they have been notified earlier. The platform may also send a notification if same users recommended the same business second or consecutive time.

Moreover, the platform may only provide a total count and list of users from their circle instead of providing count and list of only new users, who have recommended the same business. However, the platform is also capable of providing count and list of only new users, if such option is requested. Further, if the users opted to be always notified whenever they are in proximity of any promoted business then they will always be notified with the count and list of friends (circle members) who recommended the business, even if no new user (individual or business) promoted the business.

In another embodiment, whenever a user enters in proximity of a promoted franchise of a business, the user will receive a notification corresponding to that particular franchise only, despite of a fact if friends (acquaintance) of the user recommended a different franchise of that business located at a different location, street, city, or even country. For example, if user A recommended a food franchise in city one and user B received the notification in city two while he/she was in proximity with one of its franchise in city two, the user B will be displayed information related to the local franchise in city two only and not related to the actual franchise of the city one that originally received the recommendation. The franchise information received by the user B may comprise details such as, but not restricted to, franchise name, distance, menu, address, photos, phone number, directions, hours of operations, etc.

Further, the users may also select to upload an audio, video, graphic, or a combination thereof along with the broadcasted information to their circle. For example, if a user broadcasts a particular restaurant, the user may also upload a picture of food or menu of the restaurant to make the notification more interesting for other users. Also, as restaurants usually update their specialties on daily basis, the user may upload pictures of such specialties and the platform may automatically display the updated specialties of restaurants to local users (within a specific distance). Further, if a user recommends a franchise of a restaurant from a different city, friends of the user located in different cities may be able to see menu of a local franchise (in their proximate location), as it being more relevant information.

In another exemplary embodiment of the present invention, if the user selected a movie service option from the platform, a list of movies may be displayed to the user that are available for bookings in nearby movie outlets. The user can select any movie of interest and the platform may display its show times and specific locations at which the movie can be booked. The platform may further provide an option to the user to notify all of its friends (or a selective list of user) that the user is going to watch this movie at a particular movie outlet and at a particular show time.

Similarly, the platform may facilitate the user to rate/review any movie with comments and such ratings may be visible to all other users who access the movie page information. Furthermore, if the user liked the movie and wants to notify all of friends (or selective friends) that the movie is worth watching then the user may broadcast this notification. All of the friends or followers (selected by user) may then receive the notification that the user liked and recommended this movie.

Further, in an exemplary embodiment of the present invention, if a friend of the user (broadcaster) is living in a different country with different time-zone, and if the friend opens such notification, then the friend will see the movie show timings and theater locations based on its (friend) own current location and not according to the location of the user (broadcaster). For example, if a user X is living in Australia and he/she broadcasted a movie which he/she saw in Australia, then user Y who is friend of user X and is living in United States, will receive movie details based on his/her current location in United States and not as per Australian location of the user X.

In an embodiment, movie details may comprise theater name, show times, ticket information, ticket purchase options, distance from movie theater, address of theater, contact details of theater, website of theater, cast and crew of the movie, movie trailer, review of movie, ratings of movie, collections made by movie, cover image of movie, movie image, movie name, movie category, director, producer, run time, release date, movie character names, movie hall number, name of real actors, etc.

In yet another embodiment of the present invention, the platform may enable users to search for jobs in nearby locations. The users may select if they want a job within a radius of a mile or 100 miles etc. The users may also broadcast a job in their social circle if they believe that the job may be of interest for one or more of users in their social circle. Thereby, whenever their friends will enter in proximity of any job location or any office branch of job provider, they will be notified with the count and list of friends who have recommended the job.

Further, in an embodiment of the present invention, the users may promote any information via the platform, such as, advertisements, messages, photo, video, audio, graphics, etc. Such promoted information may be notified to relevant user whenever they enter in proximity of a promoted business location or any entity. Moreover, the users may have an option to select whether they are willing to receive repetitive notifications or only new notifications, whenever they enter in proximity with a promoted business or entity.

The platform may further provide an option to individuals and business owners to promote their business over the platform. The individuals and business owners may simply upload any text, picture, audio, video, or a combination thereof on the platform and the same will be advertised to every user registered/non-registered with the platform. If the advertisement is location specific then the advertisement will be visible to the registered/non-registered users whenever they enter in proximity of the advertised business or any franchise of that business.

The advertisements may further be of four different priorities, such as, urgent, featured, spotlight, and regular advertisements. The urgent advertisements may boost the advertisements on top of the list for a particular location or business. The featured advertisements may be of second priority after the urgent advertisements and the spotlight advertisements may be of third priority after the featured advertisements. Further, the regular advertisements may be non-priority advertisements and may require no payment of virtual points or currency. However, urgent, featured, and spotlight advertisements may require payment of certain virtual points or currency.

Further, in an exemplary embodiment of the present invention, a user may receive advertisements/notifications in any manner as per the present state of the art techniques. For example, the user may receive SMS, email, push notification, pop-up notification, flash notification, audio message, video message, or a combination thereof. The user may also receive all such advertisements/notifications on a virtual wall (which can be a notification screen or wall screen, or both) where every activity of user and user's circle may be listed based on time stamp. The user may navigate the virtual wall to read all the missed or previously read advertisements/notifications.

In addition, the user may further have option to view advertisements/notifications/messages that may not belong to the user itself or to any person in user's circle. Such advertisements/notifications may be displayed based on user's search on a particular topic, business, or person. Further, the user may also have another virtual wall where all the trending notifications may be displayed to the user which may not relate to the user but may be the most broadcasted or trending notifications on the platform and might be of user's interest based on user's activity history with the platform. Such notifications may also be displayed based on user's Geo-location only.

It will be appreciated by a person having skills in the art that the present invention is being explained using popular social media activities such as movies, dining, jobs, etc. However, in no manner the scope of the invention should be restricted to these activities. The invention scope relates to any information available on Internet that can be advertised, broadcasted, suggested, promoted, or shared with one or more Internet users. Use of social network application or web-service may best define the implementation of the platform. However, the present invention is not restricted to social media or social networks only.

Additionally, the platform may provide the users two unique options of experiencing virtual reality and augmented reality along with other defined features of the platform. The users may select augmented reality option with/without use of a suitable eye-wear to locate promotional materials near a business location. Importantly, for using augmented reality option, the users need to be physically present at a business location to see and catch promotional offers or materials. Further, if the users succeeds in locating and catching the promotional materials (comprising vouchers, coupons, freebies, etc.) they may redeem them to get real time discounts or offers. Such offers may be offered for limited time period.

Moreover, the users if selected the virtual reality option, may navigate in a virtual reality world, as offered by the platform that imitates real world and real world businesses. However, the user may have the advantage of navigating the virtual world without actually or physically moving in real world. Also, the users may navigate to any of their favorite theater or restaurant in the virtual world to find certain promotional materials which can be redeemed in the real world to receive actual discounts or freebies. Such offers may attract new customers and may help the real world businesses to grow faster.

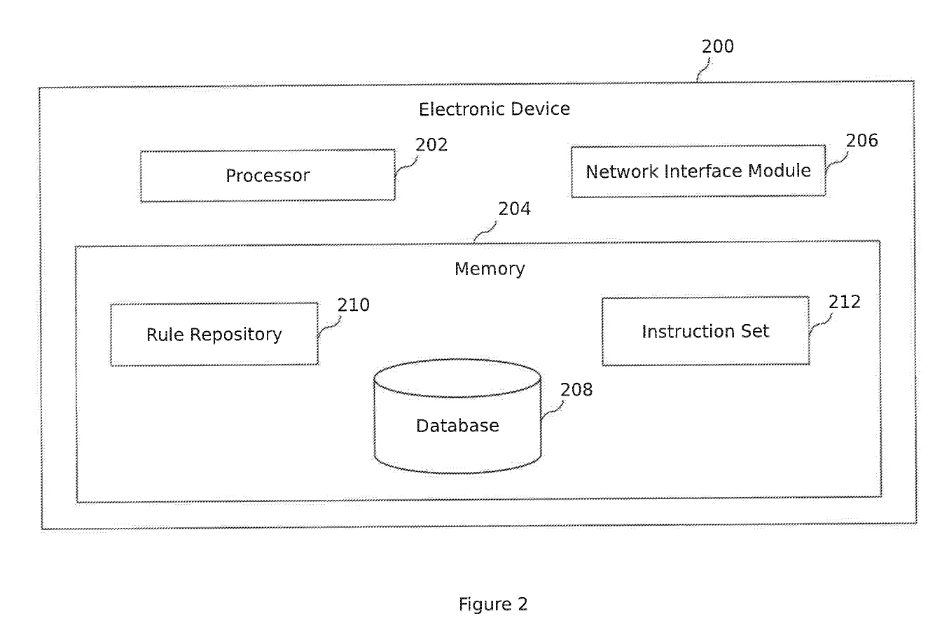

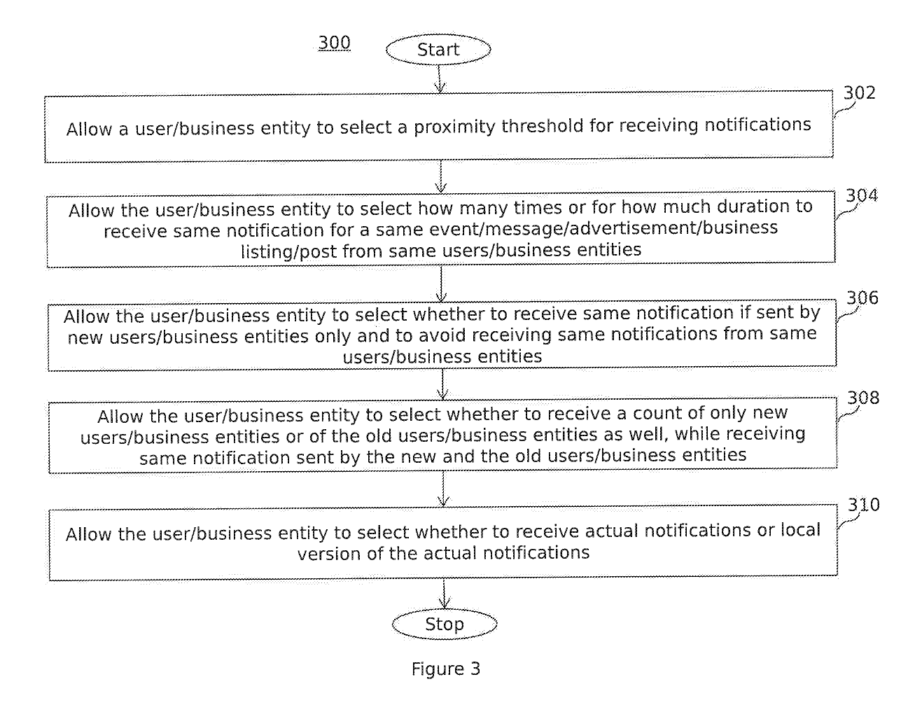

Detailed description of the aforementioned embodiments is provided further in conjunction with the FIG. 2 and FIG. 3 of the present invention.

FIG. 2 illustrates a block diagram of an electronic device 200, such as the user device 104, the vendor device 106, and the data server 102 (as explained earlier in conjunction with FIG. 1 of the present invention), in accordance with an embodiment of the present invention. As depicted from the figure, the electronic device 200 comprises a processor 202, a memory 204 for data storage, and a network interface module 206 for connecting the electronic device 200 with a network (such as the network 108 defined in conjunction with FIG. 1 of the present invention). The processor 202 may comprise one or more than one processors. The network interface module 206 may be a hardware, a software, or a combination thereof.

In an embodiment, the electronic device 200 may be a portable device such as the user device 104 and may comprise a positioning module (not shown). The positioning module may comprise a software, a hardware, or a combination thereof. The positioning module may use Wi-Fi, triangulation, GPS, or sensors for identifying Geo-location of the electronic device 200. In another embodiment, the electronic device 200 may be a web server such as the data server 102 and may not require the positioning module. However, the electronic device 200 may then need to communicate with the user device 104 and the vendor device 106 for determining their current geographical locations for providing them relevant location-based services.

Further, the memory 204 of the electronic device 200 comprises a social networking module (not shown). The social networking module may be a hardware, a software, or a combination thereof. The social networking module comprises a database 208, a user preference repository 210, and an instruction set 212. The instruction et 212 stored in the memory 204 uses the processor 202 to perform actions, e.g., receiving, storing, processing, and transmitting data stored in the memory 204. In an embodiment of the present invention, the memory 204 may either be a primary memory or a secondary memory. For example, but not restricted to, random access memory (RAM), cache memory, hard disk drive (HDD), solid state drive (SSD), compact disk (CD), portable memories, and like.

Additionally, the electronic device 200 may further include a Global Positioning System (GPS) chip (not shown) for determining precise geographical location. Also, the electronic device 200 may further include a camera and microphone (not shown), video, and audio. In addition, the electronic device 200 may further include Wi-Fi chip (not shown) for retrieving precise location of the user device.

It will be appreciated by a person skilled in the art that the aforementioned communication interfaces and location determining systems are useful in the present invention for enhancing the communication and Geo-location services. However, in no manner, these systems and interfaces should be considered as necessary components of the present invention as the present invention is implementable with and without these systems and components.

In an embodiment of the present invention, the database 208 comprises profiles of registered/non-registered individuals and business entities. Hereinafter, the registered/non-registered individuals and business entities may collectively be referred as ‘users’. Further, the user preference repository 210 comprises a user selected preferences for receiving services. In an embodiment, the user preference repository 210 may be a part of the database 208 or the memory 204 itself. However, the user preference repository 210 is separately illustrated just to ease the explanation of the present invention and to highlight importance of the user preference repository 210.

Further, the user preference repository 210 may allow any user to register preferences. The preference may comprise, but are not restricted to, a maximum distance from a geographical location to receive information corresponding to the geographical location, maximum number of times to receive same information, whether or not to receive same information from same users, whether or not to receive same information from same users if triggered second or consecutive times by the same users, whether or not to receive same information if triggered by a different user, whether or not to receive count and list of users triggering same information, whether or not to receive separate count and list of new users and separate count and list of old users triggering same information, whether or not to receive local version of a triggered information, etc.

Herein, the information comprises at least one of an advertisement, business listing, social network post, message, recommendation, audio, video, text, graphics, or a combination thereof. Further, the triggering of the information may comprise posting, broadcasting, initiating, publishing, sending, recommending, and advertising any data over a network. Such registered/non-registered preferences are parsed by the processor 202 to determine whether or not to receive/provide a service-information/product-information/advertisements/messages/posts/recommendations.

Further, the instruction set 212 may store instructions which when executed by the processor 202, causes the processor 202 to perform a step by step process. The process comprises facilitating a first user to send an information to a second user, wherein the information comprises at least one of an advertisement, business listing, social network post, message, recommendation, audio, video, text, graphics, or a combination thereof in relevance to a geographical location. The process further comprises determining whether the second user is in vicinity of the geographical location and determining whether registered/non-registered preferences of the second user allows the second user to receive the information sent by the first user. The process further comprises displaying the information to the second user if allowed by the second user's registered/non-registered preferences.

The process further comprises receiving recommendation from the second user on the displayed information and thereafter determining a list of users who have subscribed to follow activities (or is in friend list) of the second user and are also eligible to receive the information based on their own registered/non-registered preferences. Thereafter, the information is displayed to the determined list of users along with a notification that the second user recommended the information. The process further comprises notifying the second user a count and list of users who have recommended the information, wherein the count and list of users are of only those users who are subscribed by the second user. The process further comprises notifying the determined list of users a count and list of users who have subscribed to follow their activities and have also recommended the information.

The process further comprises determining whether the second user re-entered in vicinity of the geographical location and determining whether the registered/non-registered preferences of the second user allows the second user to receive the information second time. The process further comprises displaying the information to the second user if allowed by the second user's registered/non-registered preferences and displaying the second user a count and list of users who have subscribed to follow second user's activities and have also recommended the information.

In an exemplary embodiment of the present invention, the social networking module serves as a platform for consumers and vendors to consume/host a service or to buy/sell products. The social networking module also serves as a communication platform for various users to interact with each other. The social networking module may further allow the users to advertise over the platform. The social networking module may further allow the users to post updates, messages, recommendations for services/products, etc. The social networking module may further allow the users to rate services and products. The social networking module may further allow the users to post and recommend job vacancies. The social networking module may further allow the users to book or buy services such as movies, food, etc.

In another embodiment, the instruction set 212 may store instructions which when executed by the processor 202, causes the processor 202 to perform a step by step process. The process comprises facilitating a first user to send an information to a second user, wherein the information comprises at least one of an advertisement, business listing, message, recommendation, social network post, audio, video, text, graphics, or a combination thereof pertaining to a commercial item. The second user may be one or more individuals or business entities. The commercial item comprises at least one of movie, restaurant, franchise, job offer from an organization, and food item.

The process further comprises determining whether the commercial item is available in vicinity of the second user. If the commercial item is not available in vicinity, then the process displays the information to the second user. The information displayed to the second user comprises at least one of title of commercial item and count and list of users who have recommended the commercial item. Further, the count of users is restricted by count/list of only those users who are registered followers of the second user.

However, if the commercial item is available in the vicinity, then the information sent by the first user is displayed to the second user with additional details as per the second user's current geographical location. The second user is further facilitated to explore the additional details corresponding to the commercial item available in the vicinity. The details explored corresponding to the commercial item may comprise at least one of geographical location of the commercial item, distance from the second user, open and closing timings, contact details, movie start timings, food menu, daily special menu, vacancy, reservation status, title, name of business, advertisement, discount, offers, coupons, etc.

In another embodiment, the instruction set 212 may store instructions which when executed by the processor 202, causes the processor 202 to perform a step by step process. The process comprises facilitating a user to broadcast an information in one or more geographical areas, wherein the information comprises at least one of an advertisement, business listing, social network post, message, recommendation, audio, video, text, graphics, or a combination thereof.

The process further comprises determining a first set of users in vicinity of the one or more geographical areas, wherein the vicinity comprises a distance between zero to hundred miles in radius that can be updated by the user as a registered/non-registered preference analyzing registered/non-registered preferences of the first set of users to determine a second set of users qualifying for sending the broadcasted information. The one or more geographical areas may comprise one or more cities, countries, streets, malls, markets, societies, business franchises, etc. In an embodiment, a user may select a business that has multiple franchises all over the world/country/city for broadcasting the information.

The process further comprises displaying the information only to the determined second set of users and determining if the second set of users ever re-enter in vicinity of the one or more geographical areas. If the second set of users re-entered then the process further analyzes registered/non-registered preferences of the second set of users to determine a third set of users qualifying for sending the broadcasted information again, wherein the third set of users are equal or less than the second set of users. The process further comprises displaying the information again only to the third set of users.

The process further comprises receiving recommendation from a fourth set of users corresponding to the displayed information, wherein the fourth set of users are equal to or less than the second set of users. The process further comprises sending the recommendation to a fifth set of users, wherein the fifth set of users are registered/non-registered followers of the fourth set of users. The process further comprises notifying the fifth set of users that the fourth set of users have recommended the information, wherein the fifth set of users are further selected based on their registered/non-registered preferences.

The registered/non-registered preferences comprise, but are not restricted to, a maximum distance from a geographical location to receive information corresponding to the geographical location, maximum number of times to receive same information, whether or not to receive same information from same users, whether or not to receive same information from same users if triggered second or consecutive times by the same users, whether or not to receive same information if triggered by a different user, whether or not to receive count and list of users triggering same information, whether or not to receive separate count and list of new users and separate count and list of old users triggering same information, and whether or not to receive local version of a triggered information, etc.

In another exemplary embodiment of the present invention, the social networking module supports Geo-location push reminder notification in portable devices. For example, when a user A broadcast/echo (i.e. Social activity) a business listing or an advertisement to another user B or to multiple users then the user B or the multiple users will receive a notification immediately. Thereafter, whenever the user B or any of the multiple users enter in vicinity of the listed business (or advertised business), they will automatically receive a push reminder notification to remind them that user A broadcasted the business listing.

Further, the users may have an option to register their preferences (user settings) over the social networking module for receiving relevant information only from the social networking module. For example, when user B or the multiple users that received broadcasted notification are nearby physical location of business listing or advertisement for the first time, they will get push reminder notification informing that number of users (count and list of users) in their circle have broadcasted the business listing or advertisement. This preference is considered as a user preference.

Example of another preference comprises that after getting the first push reminder notification, when user B or the multiple users again enter in proximity of the same business listing's physical location or advertisement on same day or next day, when no additional or same users broadcasted same business listing or advertisement, then user B or the multiple users will not get any push reminder notification as they were already notified. However, they will get push reminder notification if there is an additional broadcasting of same business listing or advertisement made by same user A or by other users.

Similarly, as per another example of user preference, when user B or the multiple users received the broadcasted notification (arbitrary) number of times (within a day or next day etc.), they will still get a notification whenever they reenter in proximity of physical location of the business listing or advertisement informing with number of users (count and list of users) in their circle who have broadcasted the same business listing or advertisement. It is to be understood that a business listing and advertisements are different. A business listing notification may comprise information corresponding to a newly listed business on the social networking platform.

In an exemplary embodiment of the present invention, when a user Z broadcast an advertisement, business listing, job, restaurant, or movie and the same is available at physical location of receiving user Y then the receiving user Y will be displayed details such as business details, job details, restaurant menu, restaurant timings, restaurant table reservation status, movie details, movie show timings, movie theater details, etc. The displayed details will be of the nearby business/restaurant/theater of the user Y and not of the business/restaurant/theater as originally broadcasted by the user Z. This will make it convenient for the user Y to access the business/restaurant/theater in its vicinity.

Further, the user may have an option to select a maximum distance from a business's physical location up to which a business listing or advertisement corresponding to the business could be displayed to the user. For example, user can get business listing or advertisement push notification when the user is close to the business up to 0 miles, 0.5 miles, 1 mile, 10 mile, 100 mile, etc. User can select preference in term of distance. Moreover, the push reminder notification comprises count and list of friends in user's circle and title/name of the business listing or advertisement.

FIG. 3 illustrates a flow diagram 300 of a method for allowing a user to register preferences for receiving notifications from the social networking platform, in accordance with an embodiment of the present invention. Herein, at step 302 of the flow diagram 300, a data server (such as the data server 102) implementing the social networking module may receive a request from a user (individual or business entity) to allow the user to select a proximity threshold from a physical Geo-location of a business for receiving notifications corresponding to the physical location of the business from the social networking module.

For example, the user may select that a business listing or advertisement from a restaurant may only be displayed if the user is in radius of 0.5 miles from the Geo-location of the restaurant. Also, the user may select that the restaurant may only send a promotional offer if the user is only few meters away from the restaurant's Geo-location. Further, the user may select that a recommendation from a friend corresponding to the restaurant may only be displayed when the user is in same city where the restaurant is located.

At step 304 of the flow diagram 300, the data server implementing the social networking module may receive a request from a user to allow the user to select a number of times (count) to receive same notification from same users/business entities. The user may also select an option to always receive same notification (whenever user is passing by the location). The same notification comprises information corresponding to same event/message/advertisement/business-listing/post that is related to a same Geo-location. It is important that a notification is displayed to a user only when the user is within a defined distance away from a physical location of a business for which the notification is to be received.

For example, if the user wants to receive a promotional offer from a restaurant again and again whenever the user enters in vicinity of the restaurant, the user may register this preference with the social networking module. The user may also define whether the user is willing to receive same notification infinite number of times or a finite ‘X’ (arbitrary) number of times, whenever user is in vicinity of the restaurant. The scope of vicinity is also registered/non-registered by the user (as defined in step 302 of the flow diagram 300).

In another example, if a user A already received a recommendation from a user B for the restaurant, even then if the user A re-enters in vicinity of the restaurant, the user A will be re-notified that the user B recommended the restaurant. Similarly, whenever, user A will be found in vicinity of the restaurant, user A will be notified that user B recommended the restaurant. User A can set a preference that a recommendation should only be repeated X (arbitrary) number of times or for one day/month/year/decade only considering the number of times user is found in vicinity of the restaurant or any recommended business.

At step 306 of the flow diagram 300, the data server implementing the social networking module may receive a request from a user to allow the user to select whether to receive same notification again if the same notification is sent by different user(s) rather than from whom the user received it earlier. Specifically, the user may select to receive or to reject the same information if sent by the different users.

For example, if a user A already received a recommendation from a user B for a movie X, then the user A will not be notified again about the movie X. However, if later on a user C also recommended the same movie to the user A, then user A will be notified again about the movie X with an information that user C recommended the movie X and a total of two users recommended the movie. Further, if user A opted to never receive a recommendation again on movie X, then user A will never be notified about the movie X even if many other users from the circle of user A recommended the movie X at later stages. It is to be understood that the user will be notified only when the user enters in vicinity of any movie theater where movie X is available.

At step 308 of the flow diagram 300, the data server implementing the social networking module may receive a request from a user to allow the user to select whether to be notified of count and list of users who have recommended a business-listing/advertisement/message/post. The user can also request to select whether to be notified of count and list of only new users who have recommended same business-listing/advertisement/message/post/graphic/video and to avoid receiving count and list of those users who have earlier recommended the same. The user can also request to select whether to be notified of count and list of all users comprising new and old users who have recommended the same business-listing/advertisement/message/post/graphic/video.

For example, if user A opted not to receive a count and list, then the user will simply be notified that user B has recommended a job vacancy in New York city. If user C also recommends the same, then user A will again be notified that user C has recommended a job vacancy. The job vacancy details may comprise job company details, job description, salary, hourly salary, etc.

In another example, if the user A opted to receive count and list of only new users and user A already received recommendation from user B and C, then user A will not be notified again. However, if user D and E newly recommends the job vacancy, then user A will only be notified that two new users i.e., user D and E have recommended the New York job vacancy. The user A will not be notified again of the user B and user C. Though, the user A may have a separate option to view all users who have notified a particular business-listing/advertisement/message/post.

In another example, if the user A opted to receive count and list of new as well as old users and user A already received recommendation from user B and C and thereafter new users D and E also recommend the job vacancy, then user A will be notified that two new users i.e., user D and E have recommended the New York job vacancy and a total of four users have recommended the job vacancy. The user A can also be notified like four users from your friend circle have recommended a job vacancy available in New York City.

At step 310 of the flow diagram 300, the data server implementing the social networking module may receive a request from a user to allow the user to select whether to be notified of actual notifications broadcasted by other users or whether to first process the notifications and then receive processed/local version of the actual notifications comprising local information added into the actual notification.

For example, if a user A watching a movie X in London, recommends the movie X to user B who is living in Washington DC, the user B will be notified “user A recommended movie X, which is running in multiplex Y near you (1.7 miles) and you can book its next show at 4 PM today”. Such notifications may be more relevant to the users as they are tailored according to their localities. However, if the user B selected the option to receive actual notifications only, then the user B would have received a notification such as “user A recommended movie X” or “user A recommended movie X running in multiplex Z in London city”.

In another example, if user A recommended a hotel X in Las Vegas to all followers (or friends) including user B, then the social networking module will first determine location (say Chicago) of user B and then determine whether there is a chain of the hotel X in Chicago or not. If a chain of that Hotel X is found in Chicago, the social networking module will notify the user B that “user A recommended Hotel X of Las Vegas, a franchise of which is available in Chicago, just 7 miles away. Would you like to confirm a booking there?”.

In yet another example, if user A recommended a food item X from a restaurant M of San Francisco to user B residing in San Diego, the social networking module will first determine whether the recommended food item is available in any restaurant of San Diego. If found available, the social networking module will notify the user B that “user A recommended the food item X served at restaurant M of San Francisco, you can experience the same food item X from a restaurant N in San Diego, which is just half a mile away. Would you like to get directions or book a home delivery?”. It is to be understood that if a franchise of the restaurant M was available in San Diego, then the social networking module will prefer the franchise only over any other restaurant serving same food item X.

It will be appreciated by a person skilled in the art that the flow diagram 300 was illustrated for explaining various types of settings or preferences a user can register over the social networking module for filtering irrelevant information or filtering information which is not suited interest of the user. The numbers of preferences or setting defined in the flow diagram 300 are only illustrative and in no manner should be considered as limiting. More options of preferences may be introduced by the social networking platform for further tailoring information according to requirements of users.

For example, the social networking module may offer the users to select a maximum distance from a geographical location to receive information corresponding to the geographical location, maximum number of times to receive same information, whether or not to receive same information from same users, whether or not to receive same information from same users if triggered second or consecutive times by the same users, whether or not to receive, same information if triggered by a different user, whether or not to receive count and list of users triggering same information, whether or not to receive separate count and list of new users and separate count and list of old users triggering same information, whether or not to receive local version of a triggered information, etc.

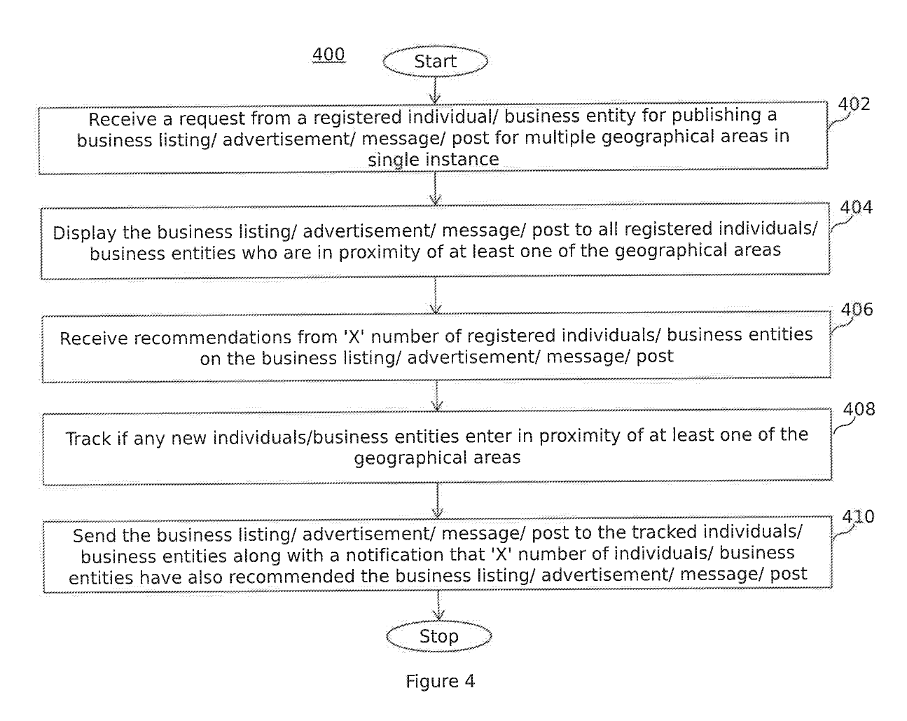

FIG. 4 illustrates a flow diagram 400 of a method for allowing a user to advertise in multiple or popular geographical locations such as cities or countries, in accordance with an embodiment of the present invention. The social networking module may provide an option to users to advertise any business listing/message/post/information to multiple geographical locations in just one attempt. The user can select or enter required geographical locations and the social networking module will broadcast in all those locations simultaneously.

The geographical locations may be streets, landmarks, towns, cities, countries, etc. The social networking module may also allow the users to select any franchised business of the world/country/city. The social networking module will automatically advertise in vicinity of all franchised business's physical location. The user can also select vicinity radius up to which the advertisement should be sent from all physical locations of the franchised business. The user may also enter different vicinity radius for different franchised business, if required.

For example, if user selected popular city option for a country, then the social networking module will automatically advertise in all popular cities of selected country. If user selected a movie, then the social networking module will automatically determine all theaters all over world where the selected movie is running, and will advertise the movie in vicinity of all of the selected theaters. This way, all registered/non-registered users of the social networking system will be notified of the advertised movie, whenever they pass by a movie theater where the selected movie is running.

In another example, if a new adventure park franchise is opened in multiple cities, then a user can select all those cities and advertise about the adventure park in those cities only. All of the social networking users in those cities will be advertised about the new adventure park in their city. If any of the users recommended the advertisement, the social networking module will automatically notify all followers of the user that the user has recommended the new adventure park, whenever they enter in vicinity of any franchise of the adventure park. If more than one user recommended the adventure park, then they will receive a count and list of users who have recommended the adventure park.

As per the flow diagram 400, which illustrates a data server (such as the data server 102) implementing the social networking module, may receive a request, at step 402, from a registered/non-registered user (individual or business entity) for publishing a business listing/advertisement/ message/post/information over the social networking platform, which should be displayed to only those registered/non-registered users who are currently located in a selected list of geographical locations, such as in selected cities of a country.

At step 404, the social networking module determines all those registered/non-registered users who are available in the selected cities and displays the business listing/advertisement/ message/post/information to the determined users. Thereafter, at least few of the users (say X users) may like the business listing/advertisement/message/post/information and may be interested to forward the information to their followers. Thereby, at step 406, the social networking module may receive a recommendation on the business listing/advertisement/message/post/information from the X users.

Thereafter, at step 408, the social networking module may track if any new registered/non-registered user entered in any of the selected city. If the new registered/non-registered users found in the selected cities, then at step 410, the social networking module may send the advertised business listing/advertisement/message/post/information to them along with a notification that X number of users have recommended the business listing/advertisement/message/post/information. More recommendations may attract more attention of users to check the advertisement or to experience the advertised business listing/advertisement/message/post/information.

In an exemplary embodiment of the present invention, the social networking module may provide various types of advertisement priorities, wherein a highest priority advertisement may surpass user preferences and may always be listed on top list to users. However, the priority based advertisement may require the users to pay money, points, etc. Details on the different types of advertisements are explained earlier in conjunction with FIG. 1 of the present invention. Further, it is to be understood that the users may register preferences with the social networking module for restricting the social networking module to provide only relevant advertisements.

The registered/non-registered preferences may comprise, but are not restricted to, a maximum distance from a geographical location to receive information corresponding to the geographical location, maximum number of times to receive same information, whether or not to receive same information from same users, whether or not to receive same information from same users if triggered second or consecutive times by the same users, whether or not to receive same information if triggered by a different user, whether or not to receive count and list of users triggering same information, whether or not to receive separate count and list of new users and separate count and list of old users triggering same information, whether or not to receive local version of a triggered information, etc.

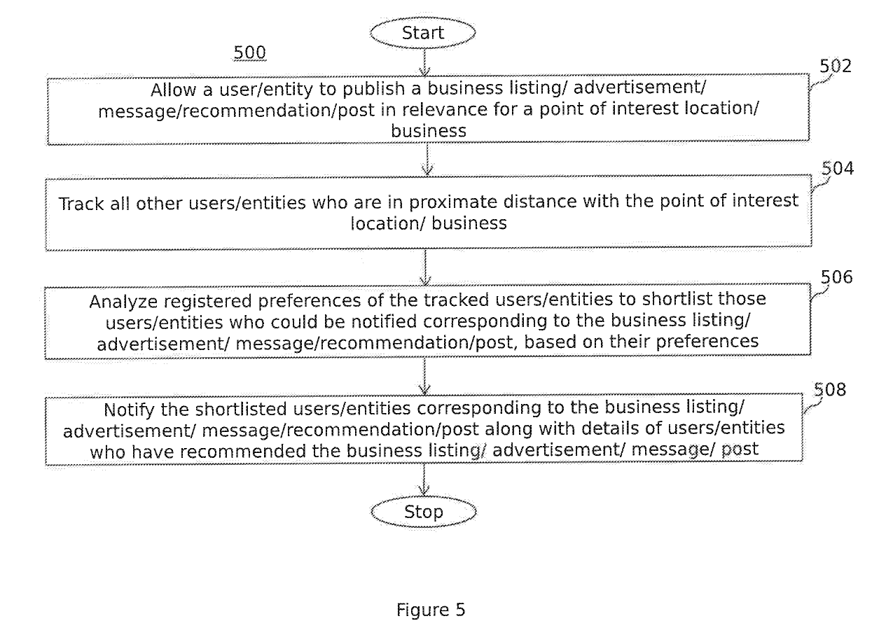

FIG. 5 illustrates a flow diagram 500 of a method for allowing a user to publish business listing/advertisement/offer/promotion/message/post/information on the social networking platform in relevance to a particular point of interest (business location), in accordance with an embodiment of the present invention.

For example, a user A may post on the social networking module that there is a job vacancy in company X of Silicon Valley. Thereafter, the social networking module may track all followers of the user A to determine those followers who are in vicinity of Silicon Valley. Thereafter, the social networking module may analyze their registered/non-registered preferences to determine whether their registered/non-registered preferences allow them to view the post. Thereafter, the social networking module may display the post of user A to the determined followers of the user A.

As per the flow diagram 500, which illustrates a data server (such as the data server 102) implementing the social networking module, may receive a request, at step 502, from a registered/non-registered user A (individual or business entity) for publishing a business listing/advertisement/message/post/information over the social networking platform in relevance to a point of interest Geo-location, wherein the Geo-location may be of any commercial or non-commercial business.

At step 504, the social networking module may track all registered/non-registered users who are in vicinity of the point of interest Geo-location. The scope of vicinity may be pre-defined. Further, the social networking module may also restrict to only followers (friends) of the registered/non-registered user A, if requested by the registered/non-registered user A. At step 506, the social networking module may analyze registered/non-registered preferences of the tracked users/followers to shortlist only those who can be notified corresponding to the business listing/advertisement/message/post/information.

The registered/non-registered preferences may comprise, but are not restricted to, a maximum distance from a geographical location to receive information corresponding to the geographical location, maximum number of times to receive same information, whether or not to receive same information from same users, whether or not to receive same information from same users if triggered second or consecutive times by the same users, whether or not to receive same information if triggered by a different user, whether or not to receive count and list of users triggering same information, whether or not to receive separate count and list of new users and separate count and list of old users triggering same information, whether or not to receive local version of a triggered information, etc.

Thereafter, at step 508, the social networking module may display the published business listing/advertisement/message/post/information to the shortlisted users/followers. Further, the social networking module may determine whether any registered/non-registered user recommended the published business listing/advertisement/message/post/information. If recommendations found, then the social networking module may also (within same notification as described earlier) notify the shortlisted users/followers with a list/count and list of users who have recommended the information. In an embodiment, the social networking module may provide the list/count and list of only followers to a user.

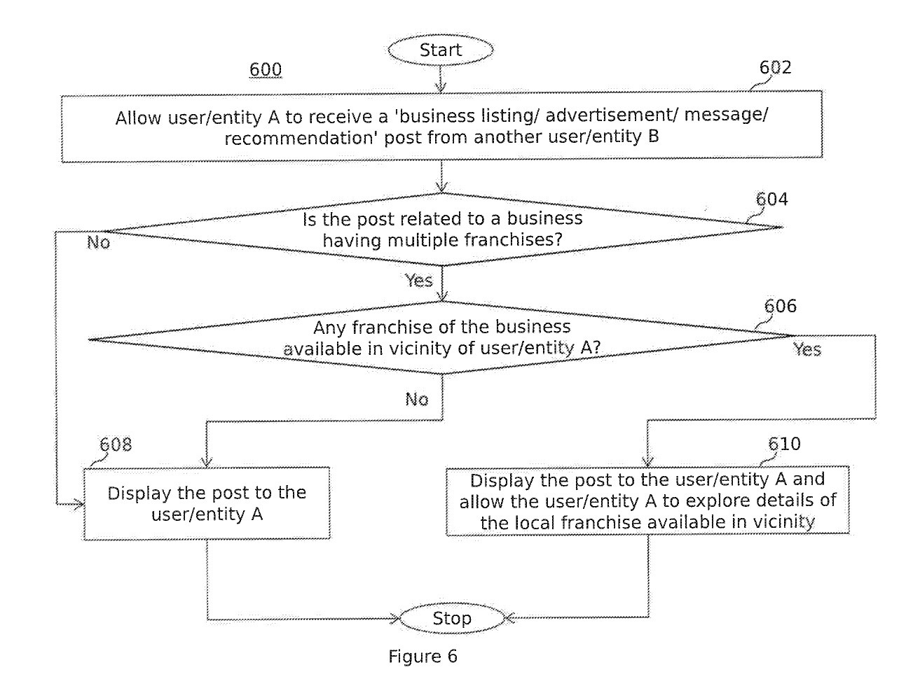

FIG. 6 illustrates a flow diagram 600 of a method for allowing a user to post a business listing/advertisement/offer/promotion/message/information on the social networking platform corresponding to a franchised business having multiple franchises all over the world, in accordance with an embodiment of the present invention. In an embodiment, the franchised business corresponds to a business registered/non-registered/owned by same entity. In another embodiment, the franchised business corresponds to a business marketed by same entity. In another embodiment, the franchised business corresponds to a business selling same commercial commodity. For example, all movie theaters all over the world may be considered as one franchised business.

For example, if a user A posted that a movie X is worth watching then the social networking module may determine location of all followers of the user A to further determine those followers who are in vicinity of a movie theater where the movie X is running. The social networking module may then notify the followers that user A recommended the movie X, which is running at a nearby movie theater that is only Y miles away. This example is not restricted by a specific theater business. Instead, all theaters are considered where the movie is available.

In another example, if a user A posted that a burger of a restaurant B is great then the social networking module may determine all franchised locations of the restaurant (not any restaurant but a restaurant owned/registered/non-registered/marketed/franchised by same entity) and then determine whether any of the user A's follower (friends) is available in vicinity of any of the determined franchised locations of the restaurant. If found, the followers (friends) will be notified that user A recommended a burger of restaurant B and a franchise of restaurant B is nearby within a mile.

It is to be understood that here in both examples, followers are notified of a business that is in their vicinity and not of the business which is actually recommended by the user A. However, the users may have an option to select whether they want to receive notifications for actually recommended businesses or their local franchise or both.

As per the flow diagram 600, which illustrates a data server (such as the data server 102) implementing the social networking module, may receive a request, at step 602, from a registered/non-registered user B (individual or business entity) for posting a business listing/advertisement/message/information over the social networking platform in relevance to a business to user A.

At step 604, the social networking module determines whether the business have franchises or not. If it is determined that there are no franchises of the posted business then the social networking module may display the post of the user B to the user A (step 608). However, if it is determined that the business is a franchised business and have multiple franchises at different locations then, at step 606, the social networking module may determine that if any of the multiple franchises of the business is available in vicinity of the user A.

If it is determined, at step 606, that a franchise of the business is not available in vicinity of the user A then the social networking module, at step 608, may display the post of the user B to the user A. However, if it is determined, at step 606, that there is a franchise in vicinity of the user A then the social networking module, at step 610, may notify the user A that user B posted corresponding to the franchised business which is just ‘Z’ (arbitrary) miles away. The user A may then have an option to browse information corresponding to the franchised business location that is Z miles away (and not the business location posted by the user B). The user A may navigate to its website, may purchase/book a product/service, get open and close timings, etc.

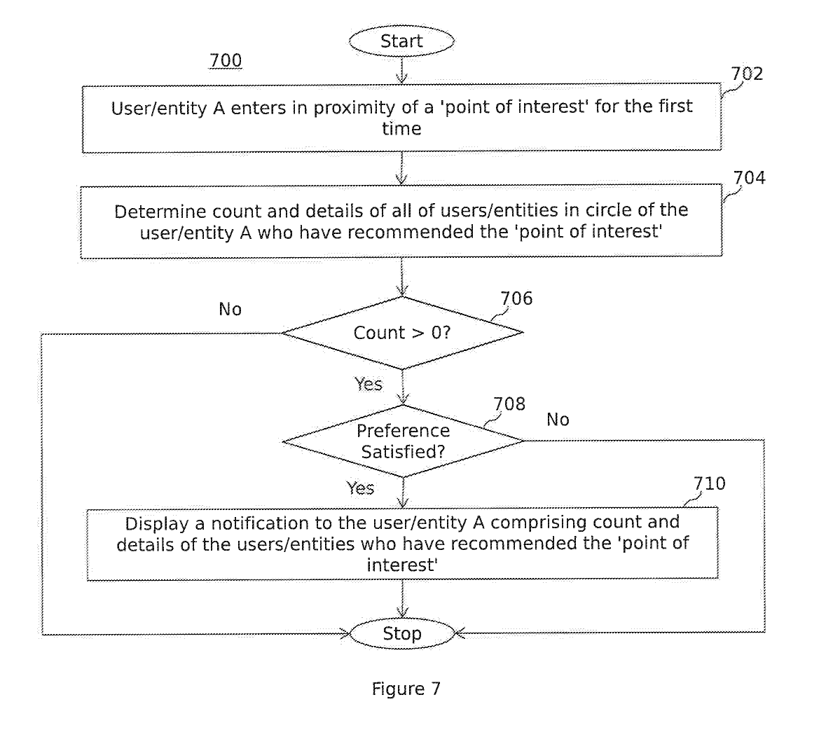

FIG. 7 illustrates a flow diagram 700 of a method for tracking Geo-locations of registered/non-registered users (of the social networking platform) for providing them relevant information/services as per their registered/non-registered preferences, in accordance with an embodiment of the present invention.

For example, the social networking module may receive posts from registered/non-registered users corresponding too many businesses located at various geographical locations. Further, the social networking module may be configured for displaying such posts only to those registered/non-registered users who are in vicinity of any of the businesses. Therefore, the social networking module may need to track Geo-locations of all of its registered/non-registered users to determine whether any of the registered/non-registered users entered in vicinity of any of the businesses. Also, the social networking module may be configured for providing such posts only to those registered/non-registered users who preferred to receive such posts (determined by their registered/non-registered preferences).

As per the flow diagram 700, which illustrates a data server (such as the data server 102) implementing the social networking module, may determine, at step 702, that a registered/non-registered user A entered in proximity of a point of interest for the first time. Herein, the point of interest refers to a Geo-location of a business or a business itself corresponding to which a post is available from another registered/non-registered user.

Thereafter, at step 704, the social networking module determines count and list and details of all registered/non-registered users in circle of the registered/non-registered user A and recommended the point of interest/business. Herein, the circle of a registered/non-registered user refers to a group of individuals or business entities who are either following each other's activities on the platform or have added each other in their friend list/acquaintance list.

Further, recommending the point of interest refers to broadcasting information corresponding to the point of interest to other users (within circle or to all users) of the social network platform and notifying them that the broadcasted information (over the social networking platform) is approved/liked/tested/recommended by them and others should also try the same. Also, it is to be understood that all the notifications provided by the social networking platform is displayed only on the social networking platform's graphical user interface.

At step 706, the social networking platform determines if any follower (or friend) (individual or entity in circle of the user A) of the user A has recommended the point of interest/business or not. If none determined, then the method flow stops and do not notify anything to the user A. However, if it is determined that one or more followers of the user A have recommended the point of interest/business then, at step 708, the social networking module analyses registered/non-registered preferences of the user A to determine whether registered/non-registered preferences of the user A are satisfied or not in relation to the point of interest and in relation to the determined one or more followers (or friends).

The registered/non-registered preferences comprise, but are not restricted to, a maximum distance from a geographical location to receive information corresponding to the geographical location, maximum number of times to receive same information, whether or not to receive same information from same users, whether or not to receive same information from same users if triggered second or consecutive times by the same users, whether or not to receive same information if triggered by a different user, whether or not to receive count and list of users triggering same information, whether or not to receive separate count and list of new users and separate count and list of old users triggering same information, whether or not to receive local version of a triggered information, etc.

At step 708, if it is determined that any of the user A's preferences is not satisfied, then user A will not be notified anything and the method flow will end. However, if it is determined that the user A's preferences are satisfied then, at step 710, user A will be notified that the user A is in vicinity of the point of interest/business, which is recommended by the determined (count and list) one or more followers. The user A may be allowed to view details of the determined one or more followers and details of the point of interest.

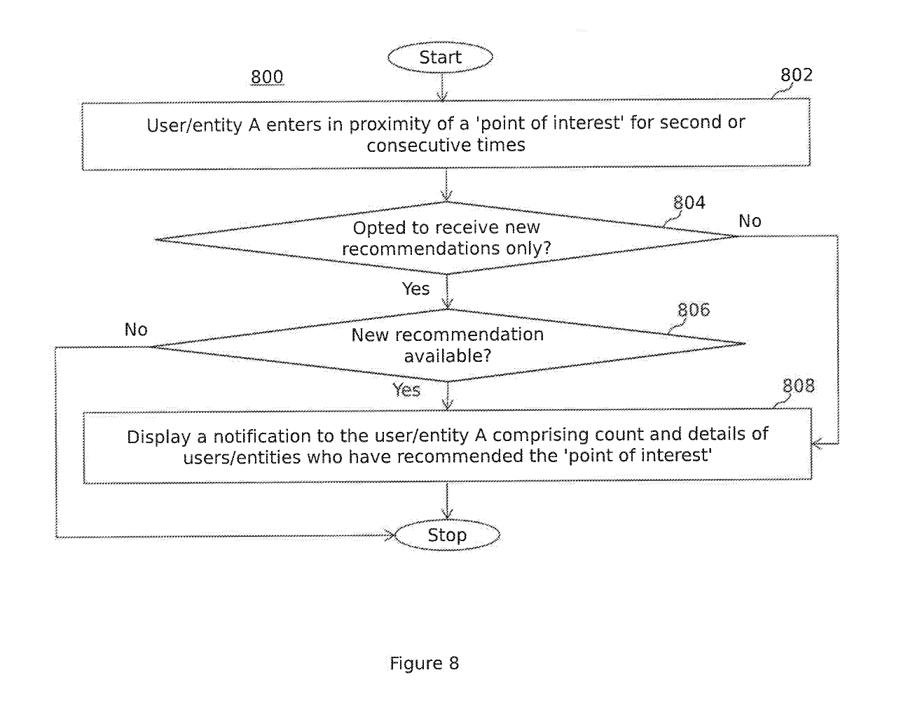

FIG. 8 illustrates a flow diagram 800 of a method of providing services to registered/non-registered users who enter in vicinity of a point of interest location/business for second or consecutive times, in accordance with an embodiment of the present invention. Further, the flow diagram 800 is in continuation of the flow diagram 700, as illustrated in FIG. 7 of the present invention.

For example, a registered/non-registered user of the social networking platform may have preferred to receive certain information for one time but may not have preferred to receive same information second or consecutive times. Also, the registered/non-registered user may have preferred to receive the same information second or consecutive times only if the same information is broadcasted/recommended by a new/different user, wherein the new/different user may or may not be a follower of the registered/non-registered user.

As per the flow diagram 800, which illustrates a data server (such as the data server 102) implementing the social networking module, may determine, at step 802, that a registered/non-registered user A entered in proximity of a point of interest for second or consecutive times. Thereafter, at step 804, the social networking module analyses registered/non-registered preferences of the user A to determine whether the user A opted to receive new recommendations only from same or different users or to receive recommendations always regardless of any new notification availability.

At step 804, if it is determined that the user A opted to receive recommendations always regardless of any new notification availability then the social networking module may display (at step 808) a notification to the user A comprising count and list and details of users (may or may not be followers of user A) who have recommended the point of interest, along with details of the point of interest. In this case, the users may be old users from whom the user A have already received recommendation when user A previously (or first time) entered in vicinity of the point of interest location/business.

However, if at step 804, it is determined that the user A opted to receive new recommendations only from same or different users then at step 806, the social networking module may determine whether recommendations from new/different users corresponding to the point of interest is available or not. At step 806, if it is determined that recommendations are not available then then the user A will not be notified of the point of interest on the second or consecutive visit in proximity of the point of interest location/business.

However, if at step 806, it is determined that new recommendations from same or old users are available then, at step 808, the social networking module may display a notification to the user A comprising count and list and details of the total users (old users as well as new users) who have recommended the information related to the point of interest. The social networking module may also notify a different count and list of new users who have recommended the information related to the point of interest.

For example, if a user A entered in vicinity of a restaurant for the first time, which is recommended by two followers (in social circle) of the user A, then if user A's preferences are satisfied, user A will be notified that two of the followers have recommended the restaurant. However, if the user A re-enter in vicinity of the same restaurant again after few minutes/hours/months/years then user A may not be notified of the same restaurant, depending on the user's preferences.

If user A preferred to receive a recommendation that is not older than a month then user A will only be notified of the recommendations that are recent than a month.

If user A preferred to receive a new recommendation only from same or different users then user A will only be notified only if a new user recommended the same restaurant or if an old user recommended the same restaurant second or consecutive times.

If user A preferred to receive a recommendation from new/different users only, then user A will only be notified if new/different users recommended the same restaurant for which the user received recommendations from old/other users.

It is to be noted that the aforementioned user preferences are for explanation purposes only and are not meant for restricting scope of the present invention. The present invention provides a scope for any user preference that a social network can accept from a user and can customize service delivery accordingly.

Although the present invention has been described in terms of certain preferred embodiments, various features of separate embodiments can be combined to form additional embodiments not expressly described. Moreover, other embodiments apparent to those of ordinary skill in the art after reading this disclosure are also within the scope of this invention. Furthermore, not all of the features, aspects and advantages are necessarily required to practice the present invention. Thus, while the above detailed description has shown, described, and pointed out novel features of the invention as applied to various embodiments, it will be understood that various omissions, substitutions, and changes in the form and details of the apparatus or process illustrated may be made by those of ordinary skill in the technology without departing from the spirit of the invention. The inventions may be embodied in other specific forms not explicitly described herein. The embodiments described above are to be considered in all respects as illustrative only and not restrictive in any manner. Thus, scope of the invention is indicated by the following claims rather than by the foregoing description.

The present invention is set forth and characterized in the independent claims, while the dependent claims describe other characteristics of the invention or variants to the main inventive idea.

What is claimed is:

1. A computer implemented method comprising:
facilitating a user to broadcast an information in one or more geographical areas, wherein the information comprises at least one of an advertisement, business listing, social network post, message, recommendation, audio, video, text, graphics, or a combination thereof, wherein the user comprises an individual or a business entity;
determining a first set of users in vicinity of the one or more geographical areas;
analyzing registered preferences of the first set of users to determine a second set of users qualifying for receiving the information;
sending the information to the second set of users;
determining if one or more users from the second set of users re-entered in the vicinity of the one or more geographical areas;
analyzing registered preferences of the determined one or more users to determine a third set of users, from the one or more users, qualifying for receiving the information again; and
sending the information again to the third set of users.

2. The computer implemented method of claim 1 further comprising:
receiving a recommendation from a fourth set of users corresponding to the sent information, wherein the fourth set of users are from the third set of users;
sending the recommendation to a fifth set of users, wherein the fifth set of users are registered followers of the fourth set of users; and
notifying the fifth set of users that the fourth set of users have recommended the information.

3. The computer implemented method of claim 2, wherein the fifth set of users are selected based on registered preferences of the fifth set of users.

4. The computer implemented method of claim 1, wherein the registered preferences of the first set of users and the registered preferences of the determined one or more users comprise one or more of:
maximum distance from a geographical location to receive information corresponding to the geographical location;
maximum number of times to receive same information;
whether or not to receive same information from same users;
whether or not to receive same information from same users if triggered second or consecutive times by the same users;
whether or not to receive same information if triggered by a different user;
whether or not to receive count of users triggering same information;
whether or not to receive separate count of new users and separate count of old users triggering same information; and
whether or not to receive local version of a triggered information.

5. The computer implemented method of claim 1, wherein the vicinity comprises a distance range between zero to hundred miles in radius, wherein the distance range is selected by a user as a registered preference.

6. The computer implemented method of claim 1, wherein the one or more geographical areas comprises streets, cities, or countries.

7. The computer implemented method of claim 1, wherein the one or more geographical areas comprise all franchise locations of a business.

8. A computer implemented method to facilitate social networking between a plurality of users, wherein the plurality of users comprises individuals and business entities, the method comprising:
facilitating a first user of the plurality of users to send an information to a second user of the plurality of users, wherein the information comprises at least one of an advertisement, business listing, message, recommendation, social network post, audio, video, text, graphics, or a combination thereof pertaining to a commercial item;
determining whether the commercial item is available in vicinity of the second user;
sending the information to the second user if the commercial item is not available in the vicinity of the second user; and
sending a customized information to the second user if the commercial item is available in the vicinity of the second user, wherein the customized information facilitates the second user to explore details corresponding to the commercial item available in the vicinity.

9. The computer implemented method of claim 8, wherein the commercial item comprises a service.

10. The computer implemented method of claim 8, wherein the details corresponding to the commercial item comprise one or more of geographical location, distance from the second user, opening and closing timings, contact details, movie start timings, food menu, daily special menu, vacancy, reservation status, title, name of business, advertisement, discount, offers, and coupons.

11. The computer implemented method of claim 8, wherein the information and the customized information sent to the second user comprises one or more of title of commercial item, count of users who have recommended the commercial and list of users who have recommended the commercial item.

12. The computer implemented method of claim 11, wherein the count of users is restricted to count of users who are registered followers of the second user.

13. The computer implemented method of claim 8, wherein the commercial item comprises a product.

14. The computer implemented method of claim 8, wherein the second user comprises one or more individuals and business entities.

15. A computer implemented method to facilitate social networking between a plurality of users, wherein the plurality of users comprises individuals and business entities, the method comprising:
facilitating a first user of the plurality of users to send an information to a second user of the plurality of users, wherein the information comprises at least one of an advertisement, business listing, social network post, message, recommendation, audio, video, text, graphics, or a combination thereof in relevance to a geographical location;
determining whether the second user is in vicinity of the geographical location;
determining whether registered preferences of the second user allow the second user to receive the information, if the second user is determined in the vicinity of the geographical location;
sending the information to the second user if allowed by the second user's registered preferences;
receiving recommendation from the second user for the sent information;
determining one or more users who have subscribed to follow activities of the second user and are also eligible to receive the information based on registered preferences of the one or more users; and
notifying the determined one or more users that the second user recommended the information.

16. The computer implemented method of claim 15 further comprising:
notifying the second user a count of users who recommended the information; and
notifying the second user a list of users who recommended the information.

17. The computer implemented method of claim 16, wherein the count of users comprises count of those users of whom the second user is a registered follower.

18. The computer implemented method of claim 15 further comprising:
notifying the determined one or more users a count of users who are following their activities and recommended the information.

19. The computer implemented method of claim 15 further comprising:
determining whether the second user re-entered in the vicinity of the geographical location;
determining whether the registered preferences of the second user allows the second user to receive the information second time;
sending the information again to the second user if allowed by the second user's registered preferences; and
sending the second user a count of users who are following the second user's activities and recommended the information.

20. The computer implemented method of claim 15, wherein the registered preferences of the second user and the registered preferences of the one or more users comprise one or more of:
maximum distance from a geographical location to receive information corresponding to the geographical location;
maximum number of times to receive same information;
whether or not to receive same information from same users;
whether or not to receive same information from same users if triggered second or consecutive times by the same users;
whether or not to receive same information if triggered by a different user;
whether or not to receive count of users triggering same information;
whether or not to receive separate count of new users and separate count of old users triggering same information; and
whether or not to receive local version of a triggered information.
